(19) United States
(12) Patent Application Publication
(10) Pub. No.: US 2026/0228175 A1
(43) Pub. Date: Aug. 6, 2026

(54) INFORMATION PROCESSING DEVICE, AND CONTROL METHOD AND PROGRAM THEREFOR

(71) Applicant: Sony Interactive Entertainment Inc., Tokyo (JP)

(72) Inventors: Minami Nagi, Kanagawa (JP); Hideyuki Saito, Chiba (JP); Hiroshi Kyusojin, Tokyo (JP); Atsushi Okumura, Tokyo (JP); Junya Miura, Kanagawa (JP)

(21) Appl. No.: 19/535,844

(22) Filed: Feb. 10, 2026

Related U.S. Application Data
(63) Continuation of application No. PCT/JP2024/028763, filed on Aug. 9, 2024.

(30) Foreign Application Priority Data
Aug. 24, 2023 (JP) 2023-136471

(51) Int. Cl. G06F 13/42; G06F 1/3206

(52) U.S. Cl. CPC G06F 13/4282; G06F 1/3206

(57) ABSTRACT

An information processing device comprising a first integrated circuit, a second integrated circuit, and a first bus and a second bus that connect the first integrated circuit and the second integrated circuit independently of each other, wherein the first integrated circuit comprises a first bus controller that controls communication via the first bus and a second bus controller that controls communication via the second bus, and when communication via the first bus is unavailable, the first integrated circuit transmits data to the second integrated circuit via the second bus using the second bus controller.

### CROSS-REFERENCE TO RELATED APPLICATIONS

This application is a continuation application of and claims the benefit of priority to International Application No. PCT/JP2024/028763, filed on August 9, 2024, which claims priority to Japanese Application No. 2023-136471, filed August 24, 2023, the contents of which are hereby incorporated by reference.

### FIELD

The present specification relates to an information processing device including a plurality of integrated circuits, a control method therefor, and a control program therefor.

Some information processing devices include a plurality of integrated circuits that function independently of each other. Such an information processing device includes a bus interface for transmitting and receiving data between a plurality of integrated circuits.

### SUMMARY

The bus controller that controls the bus interface described above may have a function to reduce overall power consumption by, for example, transitioning to a low-power (inactive) state when communication between integrated circuits is not required. However, such a function may cause a delay in communication when returning from a power-saving state, and may not be able to effectively reduce power consumption depending on the frequency of communication that occurs.

The present specification has been made in consideration of the above-mentioned circumstances, and one of its objects is to provide an information processing device, a control method thereof, and a control program thereof that can efficiently realize communication between integrated circuits.

An information processing device according to one embodiment of the present specification is an information processing device comprising a first integrated circuit, a second integrated circuit, and a first bus and a second bus that connect the first integrated circuit and the second integrated circuit independently of each other, wherein the first integrated circuit comprises a first bus controller that controls communication via the first bus and a second bus controller that controls communication via the second bus, and when communication via the first bus is unavailable, the first integrated circuit transmits data to the second integrated circuit via the second bus using the second bus controller.

A control method for an information processing device according to one embodiment of the present specification is an information processing device control method comprising a first integrated circuit, a second integrated circuit, and a first bus and a second bus that connect the first integrated circuit and the second integrated circuit independently of each other, wherein the first integrated circuit comprises a first bus controller that controls communication via the first bus and a second bus controller that controls communication via the second bus, and when communication via the first bus is unavailable, the first integrated circuit transmits data to the second integrated circuit via the second bus using the second bus controller.

A program according to one embodiment of the present specification is a program for controlling the information processing device comprising a first integrated circuit, a second integrated circuit, and a first bus and a second bus that connect the first integrated circuit and the second integrated circuit independently of each other, wherein the first integrated circuit comprises a first bus controller that controls communication via the first bus and a second bus controller that controls communication via the second bus, and when communication via the first bus is unavailable, the program causes the first integrated circuit to execute a process to transmit data to the second integrated circuit via the second bus using the second bus controller. This program may be provided by being stored in a computer-readable non-transitory information storage medium.

### BRIEF DESCRIPTION OF THE DRAWINGS

FIG. 1 is a block diagram illustrating an example of a configuration of an information processing device according to an embodiment.

FIG. 2 is a timing chart for explaining the contents of control executed by a subchip when the system is started.

FIG. 3 is a timing chart for explaining the contents of control executed by a subchip when the high-speed bus controller transitions to a power-saving state.

FIG. 4 is a timing chart for explaining the contents of control executed by a subchip when communication occurs while the high-speed bus controller is in a power-saving state, and the controller is not transitioned to the active state.

FIG. 5 is A diagram for comparing the control during data transfer in an information processing device according to an embodiment with the control during data transfer in a conventional information processing device.

FIG. 6 is a timing chart for explaining the contents of control executed by a subchip when communication occurs while the high-speed bus controller is transitioning into a power-saving state, and the controller is transitioned to the active state.

FIG. 7 is a flowchart illustrating an example of a flow of processing executed by a subchip.

FIG. 8 is a block diagram illustrating an example of a configuration of an information processing device according to other embodiments.

### DETAILED DESCRIPTION

Hereinafter, embodiments of the present specification will be described in detail with reference to the drawings.

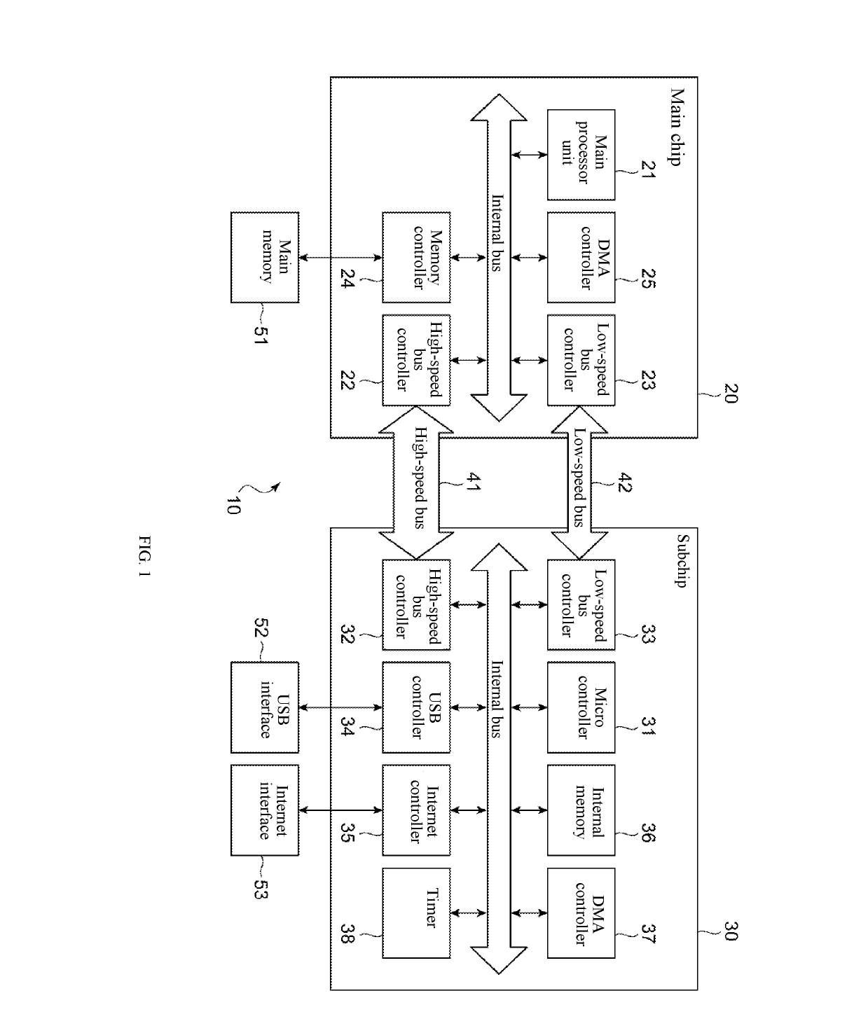

FIG. 1 is a block diagram illustrating an example of a configuration of an information processing device 10 according to an embodiment. The information processing device 10 is a home game console, a portable information terminal, a personal computer, etc., and as shown in the figure, is composed of a main chip 20, a subchip 30, a high-speed bus 41, a low-speed bus 42, a main memory 51, a USB interface 52 which is a communication interface based on the USB® standard, and an Ethernet interface 53 which is a communication interface based on Ethernet®. The subchip 30, main chip 20, high-speed bus 41, and low-speed bus 42 in the present embodiment are examples of the first integrated circuit, second integrated circuit, first bus, and second bus in the present specification, respectively.

The main chip 20 is an integrated circuit that incorporates a processor for executing the main information processing required to realize the functions of the information processing device 10. The subchip 30 is an integrated circuit which has a processor built in for realizing auxiliary functions for the main chip 20, and is implemented as an integrated circuit independent of the main chip 20. The main chip 20 and the subchip 30 are connected by two types of buses, a high-speed bus 41 and a low-speed bus 42, which are independent of each other, and are capable of transmitting and receiving data to and from each other via these buses. In the present embodiment, both the high-speed bus 41 and the low-speed bus 42 are buses capable of bidirectional data communication.

As shown in FIG. 1, the main chip 20 includes the following on-board components: a main processor unit 21, a high-speed bus controller 22 , a low-speed bus controller 23, a memory controller 24, and a DMA controller 25. The main chip 20 may include various on-board circuits other than those shown here. It may also be provided with an interface for connecting to other electronic components which are not illustrated.

The main processor unit 21 is a processor that performs various arithmetic operations according to programs stored in the main memory 51.

The high-speed bus controller 22 is a control circuit for controlling communication with the subchip 30 via the high-speed bus 41. Additionally, the low-speed bus controller 23 is a control circuit for controlling communication with the subchip 30 via the low-speed bus 42.

The high-speed bus 41 is a bus that allows data communication at a relatively high speed compared to the low-speed bus 42. Here, the high-speed bus 41 is assumed to be a bus that performs data communication based on the PCI Express® standard, but the embodiments of the present invention are not limited to this.

The low-speed bus 42 is a bus that performs data communication at a relatively low speed compared to the high-speed bus 41. That is, the low-speed bus 42 has a smaller data transfer rate per unit time than the high-speed bus 41, and the band width for data transfer is smaller than that of the high-speed bus 41. Specifically, for example, the low-speed bus 42 may be a bus that performs data communication based on an interface standard such as Quad SPI, I3C®, or MIPI®, M-PHY®, or the like.

The memory controller 24 is a control circuit connected to the main memory 51 and controls access to the main memory 51. The DMA controller 25 is a control circuit for realizing direct memory access. These circuits may all be realized by known techniques.

In the present embodiment, the subchip 30 includes the following on-board components: a microcontroller 31, a high-speed bus controller 32, a low-speed bus controller 33, a USB controller 34, an Ethernet controller 35, internal memory 36, a DMA controller 37, and a timer 38. Furthermore, the subchip 30 may include various on-board circuits other than those shown here. It may also be provided with an interface for connecting to other electronic components which are not illustrated.

The microcontroller 31 is a processor for controlling the overall operation of the subchip 30, and performs various arithmetic processing in accordance with programs stored in the internal memory 36 or the like. In particular, in the present embodiment, the microcontroller 31 controls switching between inter-processor communications using the high-speed bus 41 and the low-speed bus 42. A specific example of the control process executed by the microcontroller 31 in the present embodiment will be described later.

The high-speed bus controller 32 is a control circuit for controlling communication with the subchip 20 via the high-speed bus 41. As mentioned above, it is assumed here that the high-speed bus controller 32 performs communication based on the PCI Express standard. Additionally, the low-speed bus controller 33 is a control circuit for controlling communication with the main chip 20 via the low-speed bus 42. The high-speed bus controller 32 and low-speed bus controller 33 in the present embodiment are examples of the first bus controller and second bus controller, respectively, in the present specification.

In the present embodiment, the high-speed bus controller 32 controls the transition of its own state in order to reduce power consumption. Specifically, the high-speed bus controller 32 transitions to one of a plurality of states depending on the situation. The plurality of states include an active state in which communication with the main chip 20 is possible, and a power-saving state in which communication is restricted but consumes less power than the active state. If a state in which no communication with the main chip 20 is performed continues for a predetermined period of time, the high-speed bus controller 32 automatically transitions to a power-saving state. This allows power consumption to be reduced compared to when the device is always operating in an active state.

The x controller 34 is a control circuit connected to the USB interface 52 and performs data communication with a USB device connected to the information processing device 10 via the USB interface 52.

The Ethernet controller 35 is a control circuit connected to the Ethernet interface 53, and performs data communication with a network device connected to the information processing device 10 via the Ethernet interface 53.

The internal memory 36 stores some of the programs executed by the microcontroller 31 and the main processor unit 21 of the main chip 20. In particular, the microcontroller 31 may execute various control processes according to the program stored in the internal memory 36.

The DMA controller 37 is a control circuit for realizing direct memory access. The timer 38 is an electronic circuit that realizes a timekeeping function. These circuits may all be realized by known techniques.

In the present embodiment, the main chip 20 and the subchip 30 perform data communication with each other via either a high-speed bus 41 or a low-speed bus 42. In particular, when transmitting data from the subchip 30 to the main chip 20, the microcontroller 31 controls bus switching to control which bus the data is transmitted through. More specifically, the microcontroller 31 controls status information indicating whether the high-speed bus 41 and the low-speed bus 42 are in a communication-enabled state (Enabled) or a communication-disabled state (Disabled). When a data transfer request (command) to the main chip 20 occurs, the data to be transmitted is written to either the data buffer for the high-speed bus 41 or the data buffer for the low-speed buffer 42 according to this status information. The data stored in each data buffer is then transmitted to the main chip 20 by the corresponding bus controller. Therefore, as will be described in detail below, the microcontroller 31 can stop or start accepting data transfers by each bus controller by changing this status information depending on the state of the high-speed bus controller 32 and the low-speed bus controller 33, and can switch the bus used for transmitting data at any timing.

The following describes several specific examples of control executed by the microcontroller 31 when transmitting data from the subchip 30 to the main chip 20.

First, as a first example, a control when the system startup process of the information processing device 10 is performed, such as when the power of the information processing device 10 is turned on, will be described.

When the system starts up, the main processor unit 21 of the main chip 20 needs to load programs such as boot code and BIOS programs stored in the internal memory 36 of the subchip 30 or in a flash memory (not illustrated) connected to the subchip 30. Therefore, data transfer from the subchip 30 to the main chip 20 would be required.

On the other hand, in order to put the high-speed bus controller 32 into the active state, the microcontroller 31 must load firmware for the high-speed bus controller 32 and execute initialization processing. Furthermore, prior to the initialization process of the high-speed bus controller 32, the microcontroller 31 itself must also load necessary programs from an external flash memory and execute initialization processes such as initializing various hardware components. Then, data cannot be transferred from the subchip 30 to the main chip 20 via the high-speed bus 41 until the initialization process of the high-speed bus controller 32 is completed.

Therefore, in the present embodiment, at least a part of the data such as the boot code to be transmitted to the main chip 20 at system startup is transmitted via the low-speed bus 42. Here, it is assumed that the low-speed bus controller 33 does not require initialization processing and is capable of transmitting data without being controlled by the microcontroller 31.

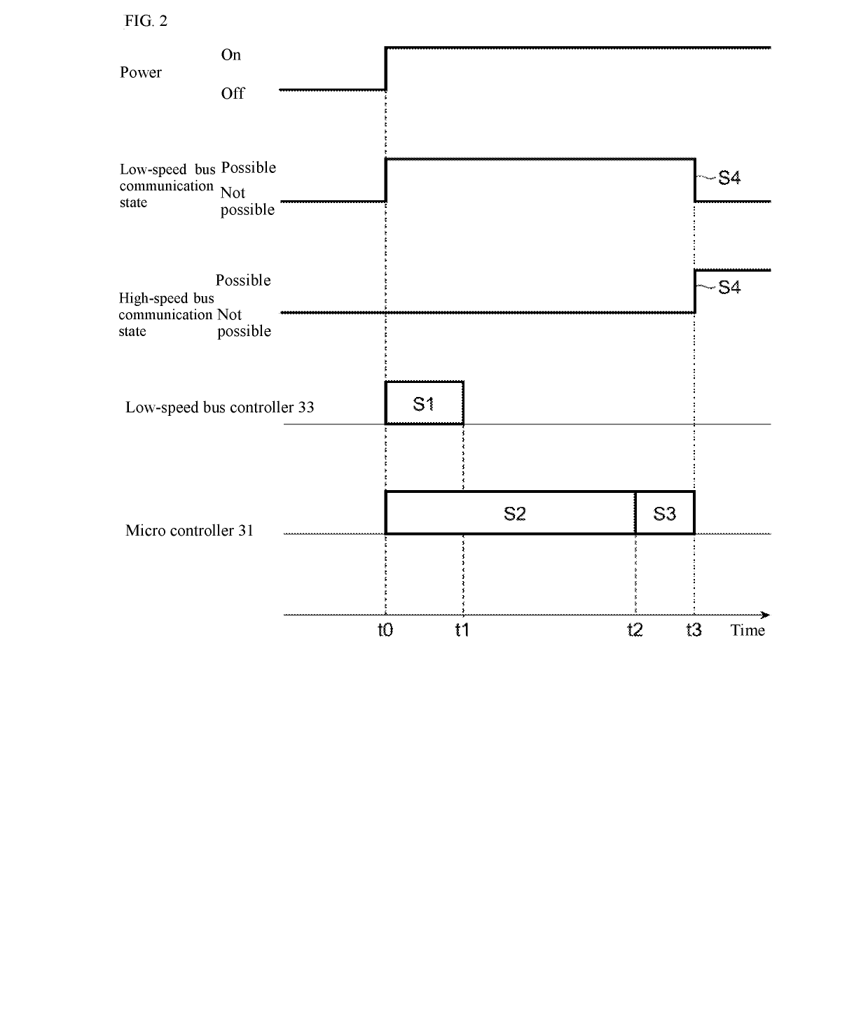

An example of the startup process executed when the information processing device 10 is started up will be described below with reference to the timing chart of FIG. 2. As shown in the figure, when the system starts to boot at time t0, the low-speed bus controller 33 first transmits the boot code to the main chip 20 via the low-speed bus 42 (S1). Note that in this case, the low-speed bus controller 33 does not require initialization processing and can immediately execute data transmission processing after system startup without going through the microcontroller 31. In this figure, the transfer of the boot code via the low-speed bus 42 is completed at time t1. Thereafter, the main processor unit 21 of the main chip 20 executes initialization processing such as initialization of various interfaces based on the loaded boot code.

In parallel with the transmission of the boot code in S1, the microcontroller 31 of the subchip 30 executes a predetermined initialization process when the system startup begins (S2). In the example shown in this figure, the initialization process of the microcontroller 31 is completed at time t2.

After the initialization process in S2 is completed, the microcontroller 31 then executes initialization process for the high-speed bus controller 32 (S3). When this initialization process is completed, the subchip 30 becomes capable of performing communication via the high-speed bus 41. Therefore, at time t3 when the processing of S3 is completed, the microcontroller 31 changes the low-speed bus 42 from a communication-enabled state to a communication-disabled state, and changes the high-speed bus 41 from a communication-disabled state to a communication-enabled state (S4). As a result, when data transmission to the main chip 20 occurs thereafter, the transmission will be performed via the high-speed bus 41.

If the low-speed bus 42 does not exist, the boot code is transmitted via the high-speed bus 41 after the initialization process of the high-speed bus controller 32 is completed. Therefore, the transmission of the boot code is completed after the start of system startup at a timing later than time t3. In contrast to this, in the present embodiment, the low-speed bus controller 33 transmits the boot code via the low-speed bus 42 in parallel with various initialization processes by the microcontroller 31, so that the transmission of the boot code can be completed before time t3 when the initialization process of the high-speed bus controller 32 is completed, thereby allowing the time required for the entire system startup process to be shortened.

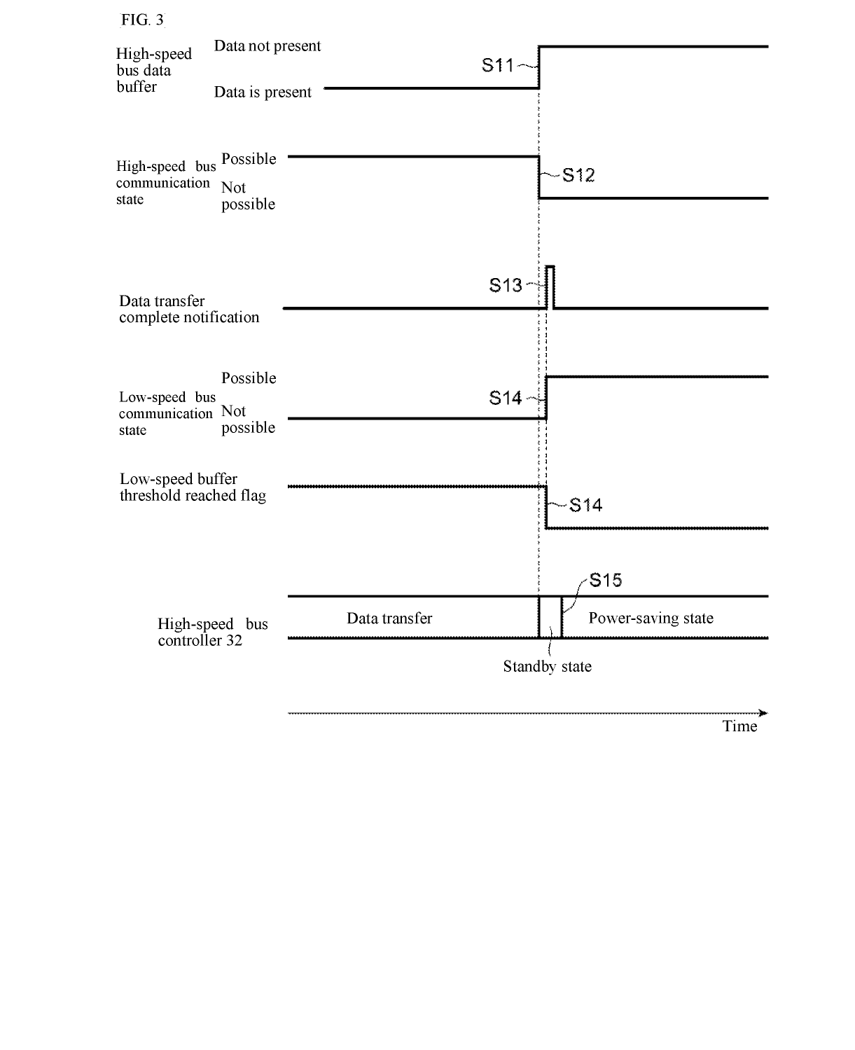

Next, the control when the high-speed bus controller 32 transitions from the active state to the power-saving state after the system startup is complete will be described with reference to the timing chart of FIG. 3.

When the data buffer of the high-speed bus 41 becomes empty (when there is no data to be transmitted), the high-speed bus controller 32 generates an interrupt to notify the microcontroller 31 to that effect (S11). In response to this, the microcontroller 31 switches the high-speed bus 41 from a communication-enabled state to a communication-disabled state (S12). As a result, new data is no longer written to the data buffer of the high-speed bus 41. As mentioned above, the high-speed bus controller 32 automatically transitions to a power-saving state when communication ceases. Therefore, even if the microcontroller 31 does not actively control the state of the high-speed bus controller 32, when data is no longer being written to the data buffer of the high-speed bus 41, the high-speed bus controller 32 transitions to a power-saving state after a predetermined time has elapsed (S15).

On the other hand, when the microcontroller 31 receives a notification of completion of data transfer in response to the command (S13), it switches the low-speed bus 42 to a communication-enabled state and clears the low-speed buffer threshold reaching interrupt flag (described below) of the low-speed bus controller 33 (S14). As a result, subsequent communication requests are accepted by the low-speed bus controller 33 and transmitted to the main chip 20 via the low-speed bus 42.

Next, the following describes the control when a data transmission request occurs while the high-speed bus controller 32 is transitioning into the power-saving state. When a request for data transmission to the main chip 20 occurs while the high-speed bus controller 32 is transitioning into the power-saving state, if the low-speed bus 42 does not exist, the high-speed bus controller 32 returns from the power-saving state to the active state, and then transmits the requested data via the high-speed bus 41. In this case, a delay occurs in communication for the time required to return from the power-saving state to the active state. Therefore, in the present embodiment, when the high-speed bus controller 32 is transitioning into the power saving state, data transmission via the low-speed bus 42 is given priority. This reduces communication delays.

Furthermore, if the microcontroller 31 determines that data can be transmitted more efficiently by returning the high-speed bus controller 32 from the power-saving state to the active state, it controls the high-speed bus controller 32 to transition to the active state. On the other hand, if the required data transfer can be completed via the low-speed bus 42, the high-speed bus controller 32 is not transitioned to the active state, and data transmission continues via the low-speed bus controller 33. This makes it possible to minimize the frequency with which the high-speed bus controller 32 transitions to the active state, thereby making it possible to reduce unnecessary power consumption.

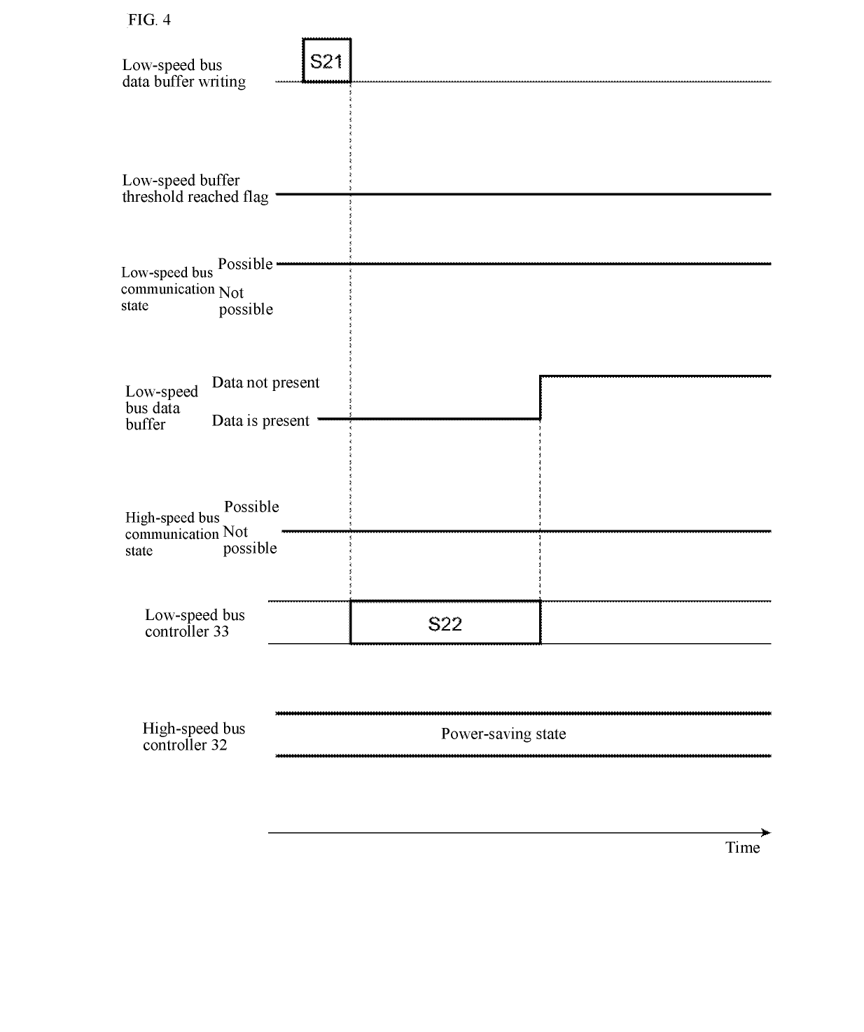

Below, the following describes a specific example of control when the high-speed bus controller 32 is transitioning into the power-saving state and transmits data via the low-speed bus 42 without transitioning to the active state with reference to the timing chart of FIG. 4.

In this example, because the high-speed bus controller 32 has transitioned to the power-saving state, the microcontroller 31 sets the high-speed bus 41 in a communication-disabled state and the low-speed bus 42 in a communication-enabled state. This is the last state in the chart of FIG. 3 mentioned above. When a data transmission request occurs in this state, the data to be transmitted to the main chip 20 is written to the data buffer of the low-speed bus 42 that is in a communication-enabled state (S21). Here, it is assumed that 2 KB of data is written to the buffer.

When the data to be transmitted is written to the data buffer, the low-speed bus controller 33 transmits the written data to the main chip 20 via the low-speed bus 42 (S22). Here, the size of the data to be transmitted is 2 kilobytes, which is a size that does not exceed a predetermined low-speed buffer threshold Th. Therefore, the low-speed bus controller 33 simply transmits the data written in the data buffer as is, and ends the transmission control when the data buffer becomes empty. During this time, the high-speed bus controller 32 remains in the power-saving state.

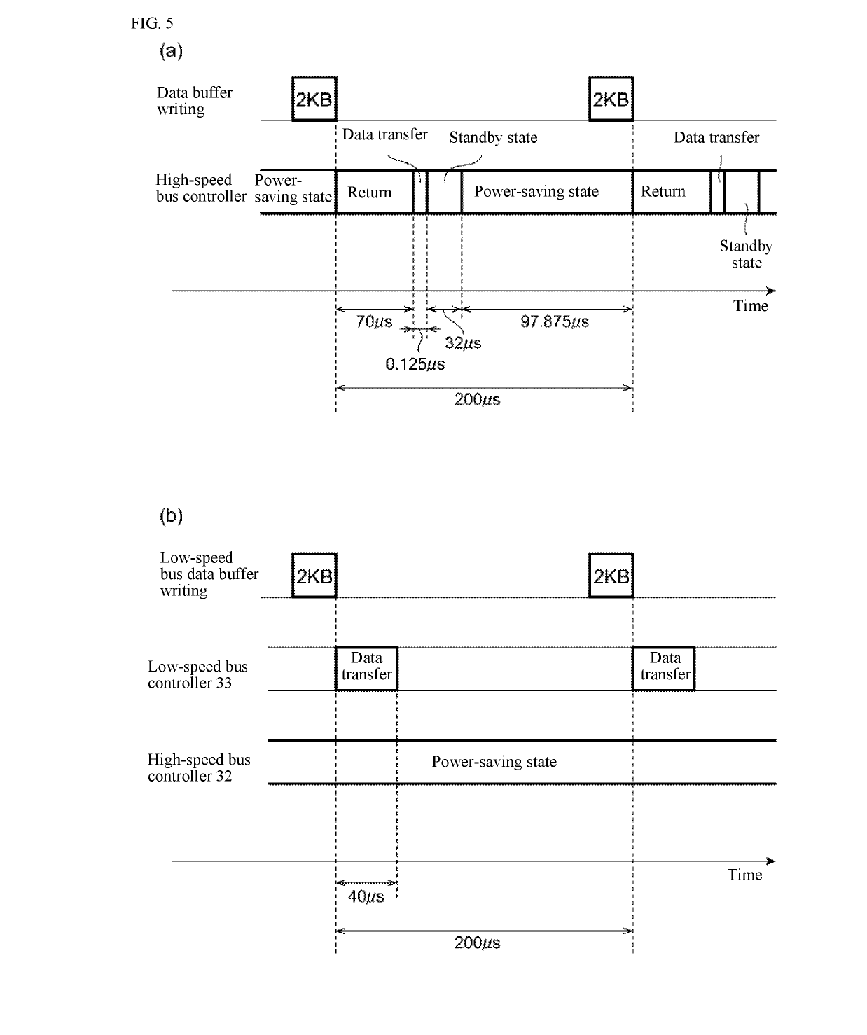

In particular, when it is necessary to periodically transmit relatively small amounts of data, without the low-speed bus 42, the high-speed bus controller 32 would return from the power-saving state to the active state every time a data transfer occurs, and the power consumption reduction effect of transitioning to the power-saving state would not be sufficiently achieved. As an example, the power-saving effect of the information processing device 10 according to the present embodiment in a case where a 2 KB data transfer is requested at a cycle of 200μs will be described with reference to FIG. 5. In this figure, the upper part of FIG. 5(a) shows an example of transmitting data via a high-speed bus in a conventional information processing device that does not have a low-speed bus 42, and the lower part of FIG. 5(b) shows an example of transmitting data via the low-speed bus 42 in this embodiment.

As a specific example, assume that the high-speed bus controller 32 transfers data at a data transfer rate of 16 GB/s, requires 70 μs to transition from the power-saving state to the active state, and transitions to the power-saving state when a waiting period without data transfer continues for 32μs. In this case, assuming that the high-speed bus controller 32 is in charge of this data transfer, it takes 0.125 μs to transfer 2 KB of data. Therefore, as shown in FIG. 5(a), the high-speed bus controller 32 operates in the active state for 102.125μs (= 70μs + 0.125μs + 32μs) each time a data transfer is performed (including the time during transition from the power-saving state to the active state). Here, data transfer occurs at a cycle of 200μs, so the remaining 97.875μs is spent operating in the power saving state. If the power consumption in the active state is 1.5 W and the power consumption in the power-saving state is 10 mW, the power consumption per second of the high-speed bus controller 32 is calculated to be 0.7708 J.

In contrast to this, in the present embodiment, as shown in FIG. 5(b), 2 KB data transfer is always executed by the low-speed bus controller 33, and the high-speed bus controller 32 is maintained in the power-saving state. Here, it is assumed that the data transfer rate of the low-speed bus 42 is 50 MB/s, and the low-speed bus controller 33 operates with a power consumption of 100 mW only during data transfer. In this case, since it requires 40 μs to transfer 2 KB of data, the average power consumption of the low-speed bus controller 33 is calculated to be 20 mW. Furthermore, since the high-speed bus controller 32 continues to operate in the power-saving state during this period, the power consumption amounts to 10 mW. Therefore, the total power consumption per second for both is calculated to be 0.03 J. That is, under these conditions, by utilizing the low-speed bus 42, it is expected that an average power reduction effect of approximately 0.74 J per second can be achieved.

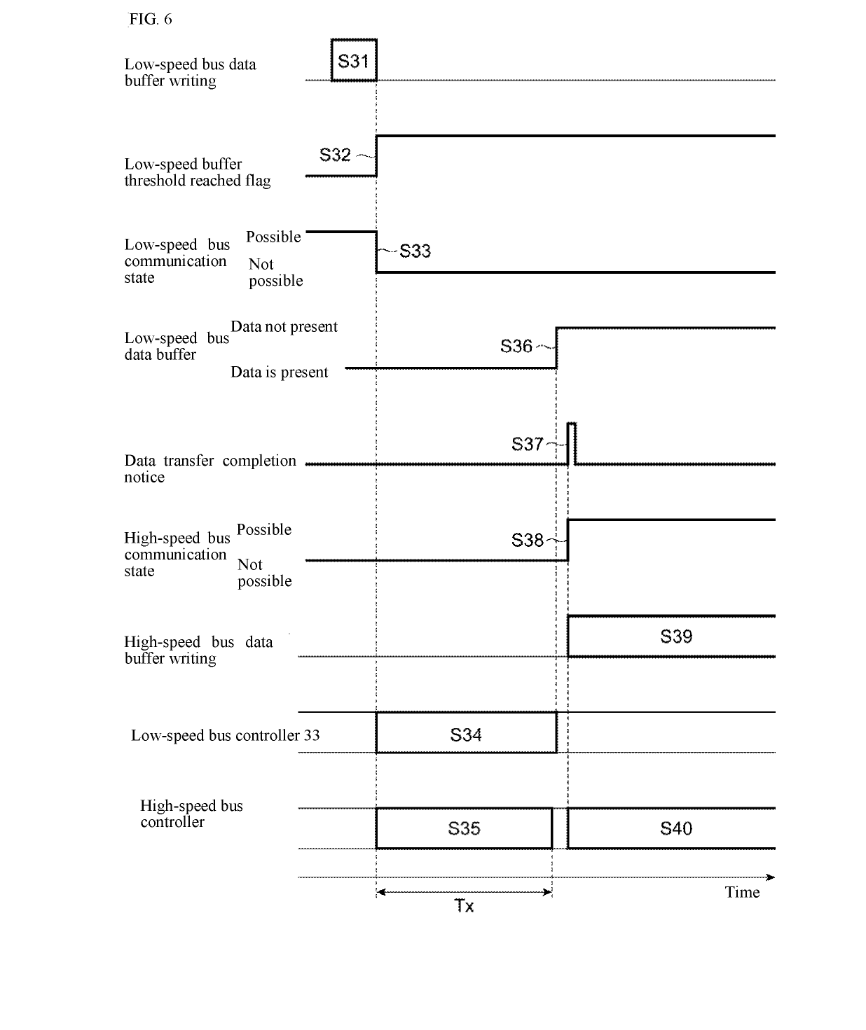

Next, the following describes an example where the data size to be transmitted exceeds the low-speed buffer threshold Th, causing the high-speed bus controller 32 to transition to the active state with reference to the timing chart of FIG. 6.

In this example as well, similar to the example in FIG. 4, the high-speed bus controller 32 transitions to a power-saving state in the initial state, the high-speed bus 41 is in a communication-disabled state, and the low-speed bus 42 is in a communication-enabled state. In this state, the data to be transmitted to the main chip 20 is written to the data buffer of the low-speed bus 42, as in the example of FIG. 4 (S31). However, in this example, unlike the example of FIG. 4, it is assumed that the size of the data to be transmitted exceeds the low-speed buffer threshold Th (here, 3.5 KB).

In this case, when the size of the data written to the data buffer reaches the low-speed buffer threshold Th, the low-speed bus controller 33 generates a low-speed buffer threshold reaching interrupt, thereby notifying the microcontroller 31 that the low-speed buffer threshold Th has been reached (S32). Upon receiving this notification, the microcontroller 31 generates a return interrupt that transitions the high-speed bus controller 32 to the active state, and changes the low-speed bus 42 to a communication-disabled state (S33). As a result, new data will no longer be written to the data buffer of the low-speed bus 42 thereafter. Therefore, the low-speed bus controller 33 transmits only the data that has been written up to that point (that is, data of a size corresponding to the low-speed buffer threshold Th) via the low-speed bus 42 (S34).

The high-speed bus controller 32 transitions to the active state in response to the return interrupt from the microcontroller 31 (S35). Here, as a specific example, it is assumed here that the recovery time Tx required for transition to the active state is approximately 70 μs.

On the other hand, the microcontroller 31 changes the high-speed bus 41 to a communication-enabled state (S38) on the condition (S37) that the data buffer of the low-speed bus 42 is empty (S36) and that a notification that the data transfer is complete is received from the low-speed bus controller 33.

When the high-speed bus 41 is in a communication-enabled state, the unsent data following the data written in the data buffer of the low-speed bus 42 is written in the data buffer of the high-speed bus 41 (S39). Upon completing the transition to the active state, the high-speed bus controller 32 transmits the data written to the data buffer to the main chip 20 via the high-speed bus 41 (S40).

Here, in steps S36-S38, the reason the high-speed bus controller 32 is changed to a communication-enabled state after the transmission completion of data by the low-speed bus controller 33 is confirmed by microcontroller 31 is to ensure that the data to be sent as requested by the sender is sent to the main chip 20 in the correct order. By this control, after the microcontroller 31 has completed transmitting data written to the data buffer of the low-speed bus 42 to the main chip 20, it can force the main chip 20 to transmit subsequent data via the high-speed bus 41, and the order in which data is transmitted can be prevented from being out of order even when switching between the two buses.

Here, while the high-speed bus 41 is changed to a communication-enabled state after the low-speed bus controller 33 has completed transmitting the data, in this case, during the period from S33 to S38, neither bus controller will be able to accept data transfer. If this situation continues, it is possible that a command overflow may occur at the sender. To avoid such a situation, the microcontroller 31 may change the high-speed bus 41 to a communication-enabled state at the same time as changing the low-speed bus 42 to a communication-disabled state, so that data can be written to the data buffer of the high-speed bus 41. In this case, however, it is desirable to have the high-speed bus controller 32 wait for data transfer until data transfer via the low-speed bus 42 is completed, so as not to reorder the data transmission order. Therefore, the microcontroller 31 may control the standby state of transfer by the high-speed bus controller 32 by setting a register or the like. In this case, the microcontroller 31 changes the setting so that the high-speed bus controller 32 is released from the standby state when it receives a notification of the completion of data transfer from the low-speed bus controller 33. The high-speed bus controller 32 refers to this setting and, after the standby state is released, starts transferring the data that has been written to the data buffer up to that point. This makes it possible to prevent a situation in which a data transfer request cannot be accepted from the perspective of the data sender while guaranteeing the data transmission order, thereby making it difficult for command overflow to occur.

In this example, the low-speed buffer threshold Th, which is the criterion for transitioning the high-speed bus controller 32 to the active state, is desirably determined based on the recovery time Tx required to transition the high-speed bus controller 32 to the active state and the data transfer rate of the low-speed bus 42. As a specific example, assume that the data transfer rate of the low-speed bus 42 is 50 MB/s and the recovery time Tx required for the high-speed bus controller 32 to transition from the power-saving state to the active state is 70μs. In this case, the low-speed bus controller 33 can transmit 3.5 KB of data via the low-speed bus 42 before the recovery time Tx has elapsed. Therefore, if the size of the data to be transmitted is equal to or smaller than this size, it is better to transmit the data via the low-speed bus 42 without returning the high-speed bus controller 32 to the active state, as shown in FIG. 4. Conversely, if it is necessary to transmit data of a size larger than this, the time required to complete transmission of the entire data can be shortened by transmitting the data that has not been transmitted via the low-speed bus 42 via the high-speed bus 41 after the high-speed bus controller 32 returns to the active state.

Therefore, in the present embodiment, the low-speed buffer threshold Th is determined depending on the data size that can be transmitted via the low-speed bus 42 before the recovery time Tx has elapsed, and when a data transfer of a size exceeding this low-speed buffer threshold Th is requested, the high-speed bus controller 32 is returned to the active state. This prevents the high-speed bus controller 32 from transitioning to the active state more than necessary. Furthermore, when the high-speed bus controller 32 is returned to the active state, it can be expected that the high-speed bus controller 32 will transition to the active state at the timing when the transmission of data equivalent to the low-speed buffer threshold Th via the low-speed bus 42 is completed, and it can be expected that the time loss due to bus switching will be minimized.

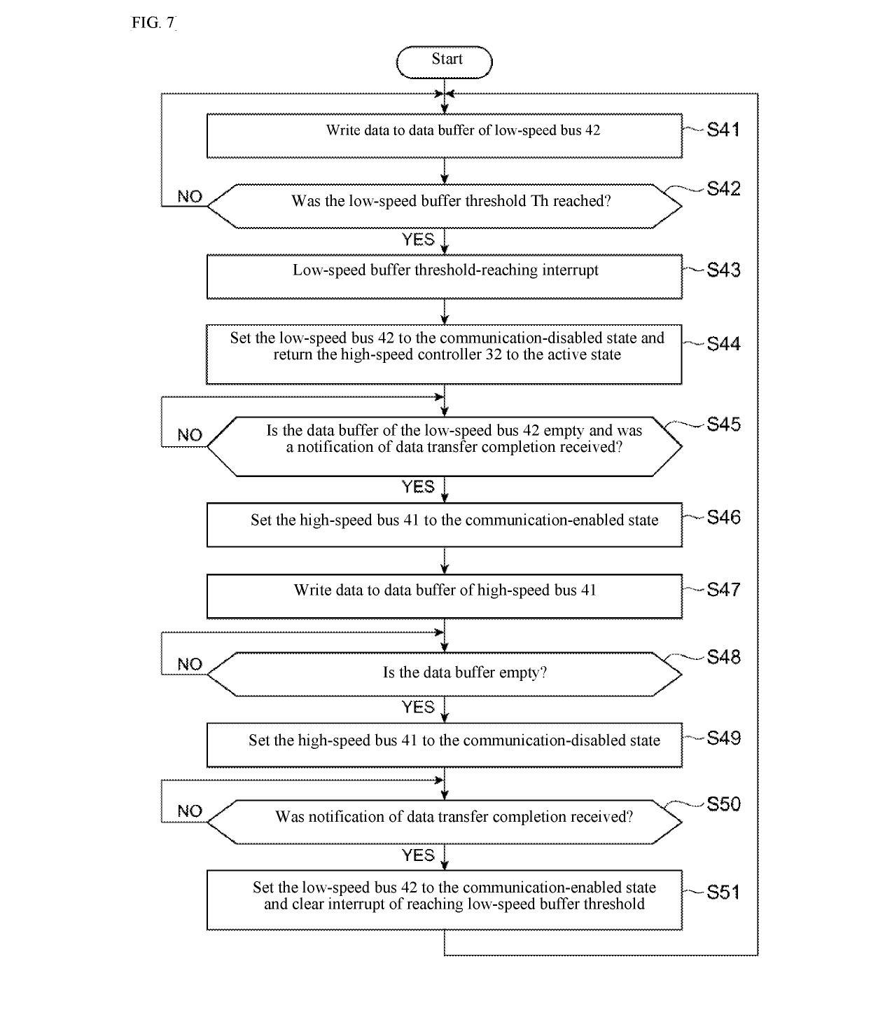

Here, an example of the overall flow of the processing executed by the subchip 30 to realize the control described above will be described with reference to the flowchart of FIG. 7. In this figure, it is assumed that initially the high-speed bus controller 32 is in a power-saving state, the high-speed bus 41 is in a communication-disabled state, and the low-speed bus 42 is in a communication-enabled state.

First, the data to be transmitted is written from the sender to the data buffer of the low-speed bus 42 (S41). The low-speed bus controller 33 continues the transfer process for written data until the size of the data written to the data buffer reaches the low-speed buffer threshold Th. When the size of the written data reaches the slow buffer threshold Th (S42), the low-speed bus controller 33 generates a low-speed buffer threshold reaching interrupt (S43).

Upon receiving this interrupt in S43, the microcontroller 31 changes the low-speed bus 42 to an communication-disabled state and generates a recovery interrupt that transitions the high-speed bus controller 32 to the active state (S44). After that, the microcontroller 31 waits until the data buffer of the low-speed bus 42 becomes empty and it receives notification from the low-speed bus controller 33 that data transfer is complete (S45). When both conditions are met, the microcontroller 31 changes the high-speed bus 41 to a communication-enabled state (S46). When the high-speed bus 41 becomes in a communication-enabled state, subsequent data from the sender is written into the data buffer of the high-speed bus 41 (S47).

In response to this, the high-speed bus controller 32 transfers the data stored in the data buffer. When the data buffer becomes empty (S48), the microcontroller 31 changes the high-speed bus 41 to an communication-disabled state (S49). Furthermore, the microcontroller 31 waits for the high-speed bus controller 32 to notify completion of data transfer (S50), changes the low-speed bus controller 33 to a communication-enabled state, and clears the low-speed buffer threshold reaching interrupt (S51). As a result, the high-speed bus controller 32 automatically transitions to the power-saving state, and the low-speed bus controller 33 returns to a state in which it can accept new data transfers.

As described above, according to the information processing device 10 of the present embodiment, the microcontroller 31 performs bus switching control, so that if the high-speed bus 41 is not immediately available, data transmission can be started via the low-speed bus 42 without causing delay, and if it would take a long time to transmit data using only the low-speed bus 42, the high-speed bus controller 32 can be transitioned to the active state, allowing communication to continue via the high-speed bus 41. This makes it possible to reduce power consumption while improving communication efficiency.

Note that the embodiments of the present specification described above are not intended to be limited to the specific examples described, and various modifications are possible. For example, in the above description, the low-speed bus controller 33 performs communication based on a bus interface that does not require initialization processing, but the bus interface of the low-speed bus 42 is not limited to this. If initialization processing is required, transmission of boot codes, etc. cannot be started immediately after system startup, but depending on the conditions, it may be possible to transmit data necessary for system startup in parallel with the initialization processing of the high-speed bus controller 32. Furthermore, after the system is started, the same bus switching control as described above can be used to reduce the number of times the high-speed bus controller 32 transitions to the active state, and data can be transferred with low latency using the low-speed bus 42.

In the above description, the microcontroller 31 in the subchip 30 executes a control program prepared in advance to control switching between the high-speed bus 41 and the low-speed bus 42. However, part or all of the control that is to be executed by the microcontroller 31 in the present embodiment may be realized by a control circuit implemented as hardware. In this case, the control circuit receives signals from the high-speed bus controller 32 indicating switching of operating states such as a power saving state, and signals indicating the presence or absence of data in the data buffer, and also receives signals from the low-speed bus controller 33 indicating the presence or absence of data in the data buffer, and an interrupt signal indicating that the low-speed buffer threshold has been reached, and outputs a control signal to switch the bus to be used depending on the content of the signals. As a result, similar to the example described above, when communication via the high-speed bus 41 is not possible, data can be efficiently transmitted to the main chip 20 using the low-speed bus 42.

In addition, in the above explanation, both the high-speed bus 41 and the low-speed bus 42 are bus interfaces capable of bidirectional data communication, but instead of the low-speed bus 42 in the embodiments described so far, two buses capable of unidirectional data transmission may be provided. In this case, one of the two unidirectional buses is used for transmission from the main chip 20 to the subchip 30, and the other is used for transmission from the subchip 30 to the main chip 20.

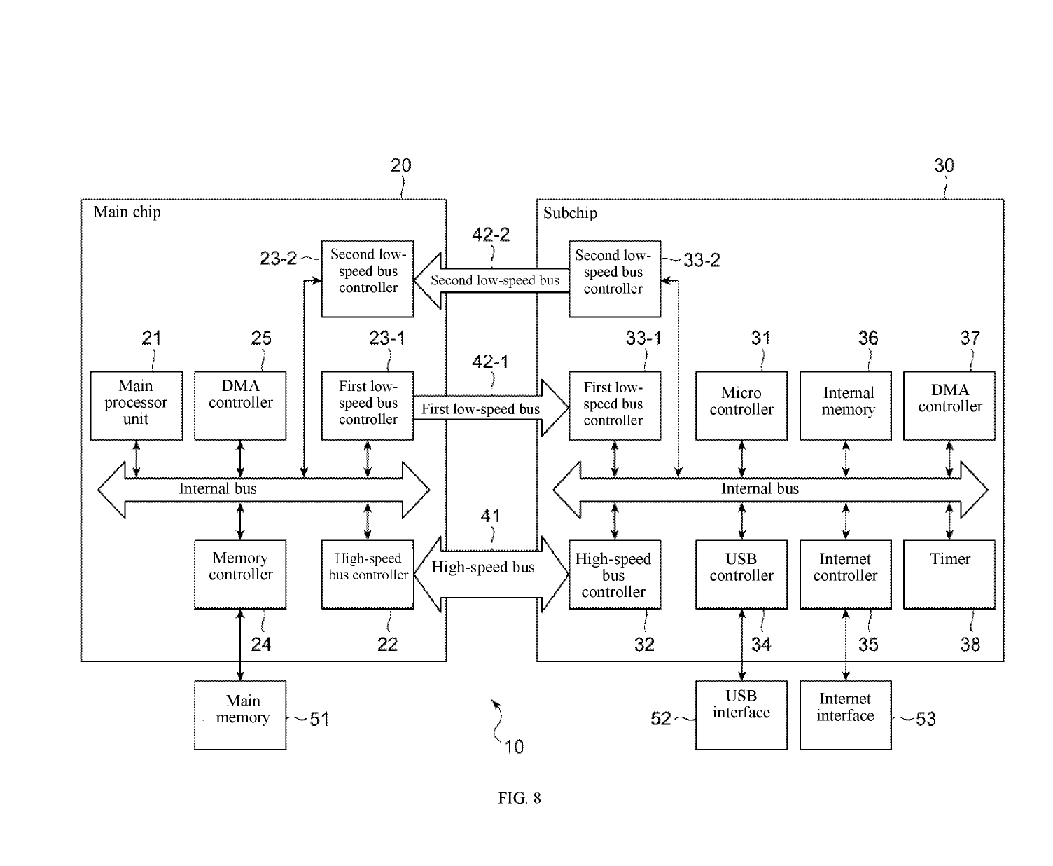

FIG. 8 is a diagram illustrating an example of a hardware configuration of this type of information processing device. In the example shown in this figure, the main chip 20 and the subchip 30 are interconnected by three buses: a high-speed bus 41, a first low-speed bus 42-1, and a second low-speed bus 42-2. The first low-speed bus 42-1 is used for transmission from the main chip 20 to the subchip 30, and the second low-speed bus 42-2 is used for transmission from the subchip 30 to the main chip 20. In addition, the subchip 30 has the following on-board components: a first low-speed bus controller 33-1 and a second low-speed bus controller 33-2 that control communications via the two low-speed buses. Similarly, the main chip 20 has the following on-board components: a first low-speed bus controller 23-1 and a second low-speed bus controller 23-2. In this example, as in the examples described so far, when the subchip 30 transmits data to the main chip 20, the microcontroller 31 of the subchip 30 controls the switching between the high-speed bus 41 and the second low-speed bus 42-2. This allows for efficient data transmission without returning the high-speed bus controller 32 to the active state more than necessary when the it is in the power-saving state.

Note that, in the example shown in this figure, the high-speed bus 41, the second low-speed bus 42-2, the high-speed bus controller 32, and the second low-speed bus controller 33-2 will function as the first bus, the second bus, the first bus controller, and the second bus controller, respectively, in the present specification.

### Description of Reference Numerals

10 Information processing device, 20 Main chip, 21 Main processor unit, 22 High-speed bus controller, 23 Low-speed bus controller, 24 Memory controller, 25 DMA controller, 30 Subchip, 31 Microcontroller, 32 High-speed bus controller, 33 Low-speed bus controller, 34 USB controller, 35 Ethernet controller, 36 Internal memory, 37 DMA controller, 38 Timer, 41 High-speed bus, 42 Low-speed bus, 51 Main memory, 52 USB interface, 53 Ethernet interface.

1. An information processing device comprising:
a first integrated circuit,
a second integrated circuit, and
a first bus and a second bus that connect the first integrated circuit and the second integrated circuit independently of each other,
wherein the first integrated circuit comprises:
a first bus controller that controls communication via the first bus; and
a second bus controller that controls communication via the second bus,
and when communication via the first bus is unavailable, the first integrated circuit transmits data to the second integrated circuit via the second bus using the second bus controller.

2. The information processing device according to claim 1,
wherein the first integrated circuit performs an initialization process of the first bus controller when system startup of the information processing device is initiated, and before the initialization process is completed, the first integrated circuit transmits data necessary for the system startup process to the second integrated circuit via the second bus.

3. The information processing device according to claim 1, wherein the first bus controller
transitions to a power-saving state based on a given condition, and when the first bus controller is in the power-saving state, the first integrated circuit transmits data to the second integrated circuit via the second bus by the second bus controller.

4. The information processing device according to claim 3, wherein the first integrated circuit transitions the first bus controller from a power-saving state to an active state when the size of data to be transmitted via the second bus exceeds a predetermined threshold.

5. The information processing device according to claim 4, wherein the first integrated circuit stops accepting data to be transmitted via the second bus when the size of the data to be transmitted via the second bus reaches a predetermined threshold, and simultaneously transitions the first bus controller from a power-saving state to an active state.

6. The information processing device according to claim 5, wherein after the first integrated circuit stops accepting data to be transmitted via the second bus, and the second bus controller subsequently completes transmission of the accepted data, the first integrated circuit initiates transmission of data by the first bus controller.

7. The information processing device of claim 1, wherein the first integrated circuit and the second integrated circuit are included in a gaming console.

8. A computer-implemented method comprising:
controlling, by a first bus controller, communication via a first bus that connects a first integrated circuit to a second integrated circuit;
controlling, by a second bus controller, communication via a second bus that is independent of the first bust and that connects the first integrated circuit to the second integrated circuit; and
when communication via the first bus is unavailable, transmitting, by the second bus controller, data from the first integrated circuit to a second integrated circuit via the second bus

9. The method of claim 8, wherein the first integrated circuit performs an initialization process of the first bus controller when system startup of the information processing device is initiated, and before the initialization process is completed, the first integrated circuit transmits data necessary for the system startup process to the second integrated circuit via the second bus.

10. The method of claim 8, wherein the first bus controller transitions to a power-saving state based on a given condition, and when the first bus controller is in the power-saving state, the first integrated circuit transmits data to the second integrated circuit via the second bus by the second bus controller.

11. The method of claim 10, wherein the first integrated circuit transitions the first bus controller from a power-saving state to an active state when the size of data to be transmitted via the second bus exceeds a predetermined threshold.

12. The method of claim 11, wherein the first integrated circuit stops accepting data to be transmitted via the second bus when the size of the data to be transmitted via the second bus reaches a predetermined threshold, and simultaneously transitions the first bus controller from a power-saving state to an active state.

13. The method of claim 12, wherein after the first integrated circuit stops accepting data to be transmitted via the second bus, and the second bus controller subsequently completes transmission of the accepted data, the first integrated circuit initiates transmission of data by the first bus controller.

14. The method of claim 8, wherein the first integrated circuit and the second integrated circuit are included in a gaming console.

15. A non-transitory computer-readable medium that stores instructions which, when executed by one or more computer processors, causes the one or more computer processors to perform operations comprising:
controlling, by a first bus controller, communication via a first bus that connects a first integrated circuit to a second integrated circuit;
controlling, by a second bus controller, communication via a second bus that is independent of the first bust and that connects the first integrated circuit to the second integrated circuit; and
when communication via the first bus is unavailable, transmitting, by the second bus controller, data from the first integrated circuit to a second integrated circuit via the second bus

16. The medium of claim 15, wherein the first integrated circuit performs an initialization process of the first bus controller when system startup of the information processing device is initiated, and before the initialization process is completed, the first integrated circuit transmits data necessary for the system startup process to the second integrated circuit via the second bus.

17. The medium of claim 15, wherein the first bus controller transitions to a power-saving state based on a given condition, and when the first bus controller is in the power-saving state, the first integrated circuit transmits data to the second integrated circuit via the second bus by the second bus controller.

18. The medium of claim 17, wherein the first integrated circuit transitions the first bus controller from a power-saving state to an active state when the size of data to be transmitted via the second bus exceeds a predetermined threshold.

19. The medium of claim 18, wherein the first integrated circuit stops accepting data to be transmitted via the second bus when the size of the data to be transmitted via the second bus reaches a predetermined threshold, and simultaneously transitions the first bus controller from a power-saving state to an active state.

20. The medium of claim 19, wherein after the first integrated circuit stops accepting data to be transmitted via the second bus, and the second bus controller subsequently completes transmission of the accepted data, the first integrated circuit initiates transmission of data by the first bus controller.
